(19) United States
(12) Patent Application Publication
(10) Pub. No.: US 2025/0010854 A1
(43) Pub. Date: Jan. 9, 2025

(54) IMAGE PROCESSING METHOD AND APPARATUS, AND STORAGE MEDIUM

(71) Applicants: SENSETIME GROUP LIMITED, Hong Kong (CN); HONDA MOTOR CO., LTD., Tokyo (JP)

(72) Inventors: Guangliang CHENG, Hong Kong (CN); Tokitomo Ariyoshi, Tokyo (JP); Umiaki Matsubara, Tokyo (JP); Yuji Yasui, Tokyo (JP); Yusuke Nakazato, Hong Kong (CN); Tatsuya Suzuki, Hong Kong (CN); Nobuaki Amano, Hong Kong (CN)

(21) Appl. No.: 18/891,102

(22) Filed: Sep. 20, 2024

Related U.S. Application Data
(63) Continuation of application No. PCT/CN2022/128952, filed on Nov. 1, 2022.

(30) Foreign Application Priority Data
Mar. 24, 2022 (CN) 202210303731.8

(51) Int. Cl. B60W 30/12; B60W 10/18; B60W 60/00; G01C 21/00; G06V 10/764; G06V 10/77; G06V 10/82; G06V 20/56; G06V 20/58; G06V 20/70

(52) U.S. Cl. CPC B60W 30/12; B60W 10/18; G01C 21/3819; G06V 10/764; G06V 10/7715; G06V 10/82; G06V 20/582; G06V 20/588; G06V 20/70; B60W 60/001; B60W 2552/10; B60W 2552/53; B60W 2556/40; G06V 2201/07

(57) ABSTRACT

An image processing method and apparatus, a device, and a storage medium. The method includes: acquiring a road image acquired by an image acquisition apparatus mounted on a vehicle; detecting multiple road boundaries in the road image on the basis of the road image; and determining a target road boundary that is dangerous to the vehicle among the multiple road boundaries. In this case, the driving of the vehicle can be controlled more accurately on the basis of the target road boundary.

### CROSS-REFERENCE TO RELATED APPLICATION

This application is a continuation application of International Patent Application No. PCT/CN2022/128952, filed on Nov. 1, 2022, which is based on and claims priority to Chinese patent application No. 202210303731.8, filed on Mar. 24, 2022 and entitled “IMAGE PROCESSING METHOD AND APPARATUS, DEVICE, AND STORAGE MEDIUM”. The contents of International Patent Application No. PCT/CN2022/128952 and Chinese patent application No. 202210303731.8 are hereby incorporated by reference in their entireties.

### BACKGROUND

In recent years, great progress has been made in the field of autonomous driving mainly based on deep learning, which includes the field of image segmentation and target detection. The autonomous driving is a whole system, and an output of a sensing module serves subsequent module. In the related art, there are many disconnections between the sensing module and the subsequent control signals, which affects control accuracy and credibility of the system.

### SUMMARY

Embodiments of the disclosure provide an image processing method, apparatus and storage medium.

The technical solutions of the embodiments of the disclosure are implemented as follows.

An embodiment of the disclosure provides an image processing method including the following operations. A road image collected by an image collection apparatus installed on a vehicle is acquired. Multiple road boundaries in the road image are detected based on the road image. A target road boundary dangerous to the vehicle is determined from the multiple road boundaries.

An embodiment of the disclosure provides an image processing apparatus, including a memory for storing instructions and a processor, the processor is configured to execute the instructions to: acquire a road image collected by an image collection apparatus installed on a vehicle; detect, based on the road image, multiple road boundaries in the road image; and determine a target road boundary dangerous to the vehicle from the multiple road boundaries.

Correspondingly, an embodiment of the disclosure provides a computer storage medium having computer-executable instructions stored thereon. The computer-executable instructions, when executed, are capable of implementing operations of: acquiring a road image collected by an image collection apparatus installed on a vehicle; detecting, based on the road image, a plurality of road boundaries in the road image; and determining a target road boundary, which is dangerous to the vehicle, from the plurality of road boundaries.

In order to make the aforementioned purposes, features and advantages of the embodiments of the disclosure more obvious and easier to understand, in the following, preferred embodiments are proposed and detailed illustration is provided in together with the accompanying drawings.

### BRIEF DESCRIPTION OF THE DRAWINGS

In order to illustrate the technical solutions of the embodiments of the disclosure more clearly, in the following, the drawings to be used in the embodiments will be introduced briefly. The drawings here are incorporated into and form a part of the specification. The drawings illustrate embodiments conforming to the disclosure and are used together with the specification to illustrate the technical solutions of the disclosure. It is to be understood that the following drawings only illustrate some embodiments of the disclosure, and thus should not be regarded as a limitation on the scope. For those of ordinary skill in the art, other relevant drawings may be obtained according to these drawings without creative effort.

FIG. 1A is a schematic diagram of a system architecture which may apply an image processing method of an embodiment of the disclosure.

FIG. 1B is a schematic implementation flowchart of an image processing method provided by an embodiment of the disclosure.

FIG. 2 is another schematic implementation flowchart of an image processing method provided by an embodiment of the disclosure.

FIG. 3 is yet another schematic implementation flowchart of an image processing method provided by an embodiment of the disclosure.

FIG. 4 is a network structure diagram of an image processing method provided by an embodiment of the disclosure.

FIG. 5A is a schematic diagram of an application scenario of an image processing method provided by an embodiment of the disclosure.

FIG. 5B is a schematic diagram of another application scenario of an image processing method provided by an embodiment of the disclosure.

FIG. 6A is a schematic diagram of an application scenario of an image processing method provided by an embodiment of the disclosure.

FIG. 6B is a schematic diagram of another application scenario of an image processing method provided by an embodiment of the disclosure.

FIG. 7 is a schematic diagram of yet another application scenario of an image processing method provided by an embodiment of the disclosure.

FIG. 8 is a schematic diagram of still yet another application scenario of an image processing method provided by an embodiment of the disclosure.

FIG. 9 is a schematic diagram of yet another application scenario of an image processing method provided by an embodiment of the disclosure.

FIG. 10 is a schematic structure composition diagram of an image processing apparatus provided by an embodiment of the disclosure.

FIG. 11 is a schematic composition structure diagram of a computer device provided by an embodiment of the disclosure.

### DETAILED DESCRIPTION

In order to make the purposes, technical solutions and advantages of the embodiments of the disclosure clearer, the specific technical solutions of the disclosure will be described in further detail below in combination with the drawings in the embodiments of the disclosure. The following embodiments are used to illustrate the disclosure, but are not intended to limit the scope of the disclosure.

In the following description, “some embodiments” describes a subset of all possible embodiments, but it is to be understood that “some embodiments” may be the same subset or different subsets of all possible embodiments, and may be combined with each other without conflict.

In the following description, the term “first/second/third” is only used to distinguish similar objects and does not represent a particular order of the objects. It is to be understood that “first/second/third” may be interchanged by a particular order or sequence when permitted, such that the embodiments of the disclosure described in some embodiments may be implemented in an order other than that illustrated or described in some embodiments.

Unless otherwise defined, all technical and scientific terms used herein have the same meaning as commonly understood by those skilled in the art falling within the disclosure. The terms used herein are only for the purpose of describing the embodiments of the disclosure, and are not intended to limit the disclosure.

Before the embodiments of the disclosure are described in further detail, the nouns and terms involved in the embodiments of the disclosure are illustrated. The nouns and terms involved in the embodiments of the disclosure are subject to the following interpretations.
1) Convolutional Neural Networks (CNN): a class of feed-forward neural networks including convolutional computation and having a deep structure. It has a representation learning capability, and is able to perform translation invariant classification on the input information according to its hierarchical structure.
(2) Ego vehicle: a vehicle that includes sensors for sensing the surrounding environment. The vehicle coordinate system is solidly attached to the ego vehicle, where the x-axis is the forward direction of the vehicle, the y-axis points to the left of the forward direction of the vehicle, and the z-axis is perpendicular to the ground and upward, which conforms to the right-handed coordinate system. The origin of the coordinate system is located on the earth below the midpoint of the rear axis.

Embodiments of the disclosure provide an image processing method and apparatus, a device, and a storage medium. The multiple road boundaries in the road image are identified by detecting the acquired road image, and the target road boundary dangerous to the vehicle is selected from the multiple road boundaries. In this way, the driving of the vehicle may be controlled more accurately based on the target road boundary.

An exemplary application that an image processing method provided by an embodiment of the disclosure is applied to an electronic device is illustrated below. The electronic device provided by the embodiment of the disclosure may be an in-vehicle device, a cloud platform, or other computer devices. Exemplarily, the in-vehicle device may be a thin client, a thick client, a microprocessor-based system, a small computer system, or the like, which is installed on a vehicle. The cloud platform may be a distributed cloud computing technology environment including a small computer system or a large computer system, or the like. In the following, an exemplary application that the electronic device is implemented as a terminal or server will be illustrated.

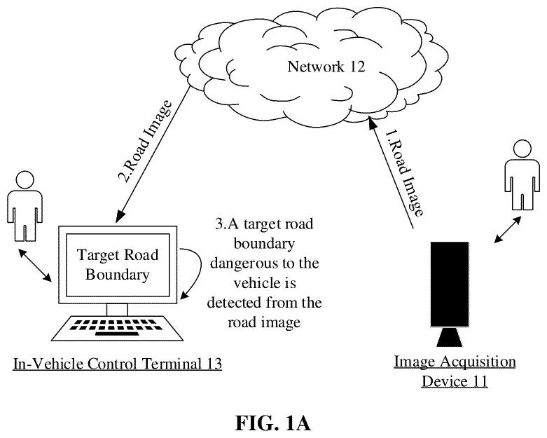

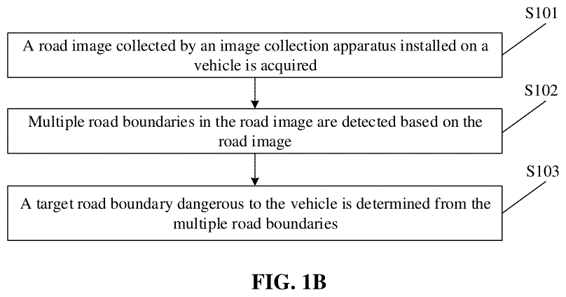

FIG. 1A is a schematic diagram of a system architecture of an image processing method provided by an embodiment of the disclosure. As shown in FIG. 1A, the system architecture includes an image acquisition device 11, a network 12, and an in-vehicle control terminal 13. To implement supporting an exemplary application, the image acquisition device 11 and the in-vehicle control terminal 13 establish a communication connection through the network 12. Firstly, the image acquisition device 11 reports an acquired road image to the in-vehicle control terminal 13 through the network 12, and the in-vehicle control terminal 13 performs road boundary detection on the road image to detect a target road boundary dangerous to the vehicle.

As an example, the image acquisition device 11 may include a vision processing device having a vision information processing capability. The network 12 may adopt a wired or wireless connection. When the image acquisition device 11 is a vision processing device, the in-vehicle control terminal 13 may be communicatively connected to the vision processing device by a wired connection, for example, may perform data communication through a bus.

Optionally, in some scenarios, the image acquisition device 11 may be a vision processing device with a video collection module, which may be a host computer with a camera. In such case, the image processing method of the embodiments of the disclosure may be performed by the image acquisition device 11, and the aforementioned system architecture may not include the network 12 and the in-vehicle control terminal 13.

In order to make the purposes, technical solutions and advantages of the embodiments of the disclosure clearer, the specific technical solutions of the disclosure will be described in further detail below in combination with the drawings in the embodiments of the disclosure. The following embodiments are configured to illustrate the disclosure, but are not intended to limit the scope of the disclosure.

In the following description, “some embodiments” describes a subset of all possible embodiments, but it is to be understood that “some embodiments” may be the same subset or different subsets of all possible embodiments, and may be combined with each other without conflict.

The method may be applied to a computer device, and functions implemented by the method may be implemented by a processor in the computer device calling program codes. Of course, the program codes may be stored in a computer storage medium. As can be seen, the computer device includes at least a processor and a storage medium.

FIG. 1B is a schematic implementation flowchart of an image processing method provided by an embodiment of the disclosure. As shown in FIG. 1B, illustration is performed in combination with operations shown in FIG. 1B.

In operation S101, a road image collected by an image collection apparatus installed on a vehicle is acquired.

In some embodiments, the road image may be a collected image of any road, and may include an image with a complex picture content or an image with a simple picture content, for example, a road image collected by an in-vehicle device on the vehicle.

In some embodiments, the image collection apparatus may be installed on the in-vehicle device or may be independent of the in-vehicle device. The in-vehicle device may be communicatively connected to a sensor, a positioning apparatus, or the like, of the vehicle. The in-vehicle device may acquire data collected by the sensor of the vehicle, geographic position information reported by the positioning apparatus, or the like, through the communication connection. Exemplarily, the sensor of the vehicle may be at least one of a millimeter wave radar, a laser radar, a camera, or the like. The positioning apparatus may be an apparatus for providing a positioning service based on at least one of a Global Positioning System (GPS), a BeiDou satellite navigation system, or a Galileo satellite navigation system.

In some embodiments, the in-vehicle device may be an Advanced Driving Assistant System (ADAS), and the ADAS is disposed on the vehicle. The ADAS may acquire real-time position information of the vehicle from the positioning apparatus of the vehicle, and/or, the ADAS may obtain image data, radar data, or the like, which indicates information of the surrounding environment of the vehicle, from the sensor of the vehicle. Optionally, the ADAS may send driving data of the vehicle including the real-time position information of the vehicle to the cloud platform, such that the cloud platform may receive the real-time position information of the vehicle and/or the image data, the radar data, or the like, which indicates the information of the surrounding environment of the vehicle.

The road image is obtained by the image collection apparatus (i.e., the sensor, such as a camera) disposed on the vehicle. As the vehicle moves, the image collection apparatus collects images around the vehicle in real time to obtain the road image. In some possible implementations, a camera installed on the vehicle may collect the road on which the vehicle is driving as well as the surrounding environment during the driving process of the vehicle, to obtain the road image. In this way, multiple road boundaries may be identified by detecting the road image.

In operation S102, multiple road boundaries in the road image are detected based on the road image.

In some embodiments, a detection network is adopted to detect the multiple road boundaries in the road image. The vehicle in the road image may be any vehicle driving on the road.

In some possible implementations, edges of the road in the road image may be detected by performing edge detection on the road image, and thereby the multiple road boundaries may be obtained. For example, the multiple road boundaries may be obtained by detecting lane lines of multiple lanes in the road image and connecting end edges of the lane lines. Alternatively, the multiple road boundaries in the road image may be outputted by inputting the road image into a trained edge detection network.

In operation S103, a target road boundary dangerous to the vehicle is determined from the multiple road boundaries.

In some embodiments, the target road boundary may be a road boundary invisible to the vehicle, or a road boundary that is identifiable by the vehicle but has a short distance from the vehicle, or a road boundary dangerous to the vehicle determined by analyzing road information in the road image. For example, a road boundary obscured by an obstacle, a road boundary that is too far away from the vehicle, a road boundary in the blind area of the vehicle, or a road boundary that is too close to the vehicle such that the vehicle cannot drive normally.

In some possible implementations, by detecting the position relationship between the obstacle and the road boundary, it may be determined whether the obstacle obscures the road boundary, and thereby it may be determined whether the road boundary is invisible, i.e., whether it is the target road boundary. By detecting the distance between the vehicle and the road boundary, it may be determined whether the road boundary is too far away from the vehicle, and thereby it may be determined whether the road boundary is the target road boundary. By detecting the position relationship between the vehicle and the road boundary, it may be determined whether the road boundary is in the blind area of the vehicle, and thereby it may be determined whether the road boundary is the target road boundary. In this way, the target road boundary dangerous to the vehicle is identified from the detected multiple road boundaries, and thus a subsequent driving path may be planned more accurately.

In the embodiment of the disclosure, the multiple road boundaries in the road image are identified by detecting the acquired road image, and the target road boundary dangerous to the vehicle is selected from the multiple road boundaries. In this way, the driving of the vehicle may be controlled more accurately.

In some embodiments, multiple road boundaries associated with the vehicle in the road image may be identified by detecting the road image. That is, the aforementioned operation S102 may be implemented in various manners as follows.

In a first manner, the road image is detected to determine multiple road boundaries associated with the vehicle.

In the first manner, a first network is used to detect the road image, and the multiple road boundaries associated with the vehicle are determined. The multiple road boundaries associated with the vehicle may be road boundaries of each lane of the road where the vehicle is located, or road boundaries of multiple lanes of the road where the vehicle is located. In a specific implementation, the vehicle may reach any lane on the road where it is located by lane changing or U-turn. Therefore, it may be considered that the road boundary of any lane on the road where the vehicle is located is a road boundary associated with the vehicle. For example, if the road where the vehicle is located includes four lanes, the multiple road boundaries associated with the vehicle include the road boundary of each of the four lanes. The first network may be a Deep Neural Network (DNN), e.g., any network capable of performing image detection. In some possible implementations, the first network may be a residual network, a Visual Geometry Group (VGG) network, or the like. The first network is a trained network capable of performing the road boundary detection. Feature extraction is performed on the road image by inputting the road image into the first network, and the multiple road boundaries associated with the vehicle may be identified based on the extracted image features. In this way, the multiple road boundaries in the road image may be identified quickly and accurately.

In addition, in a specific implementation, the road boundary associated with the vehicle may further be determined by determining an overlapping part of a freespace and a road boundary in the road image. That is, the overlapping part of the detected freespace and the detected road boundary is determined as the road boundary associated with the vehicle. The freespace may be detected by a DNN, which is not limited thereto.

In a second manner, the operation that the multiple road boundaries are determined by detecting lanes in the road image may be implemented by the following operations.

In a first operation, the road image is detected to obtain multiple lanes in the road image.

In some embodiments, the lanes in the road image are detected to obtain multiple lanes. A second network is used to detect the lanes in the road image to obtain the multiple lanes. The second network may be the same or different from the first network. The multiple lanes in the road image are detected by the second network, i.e., multiple lane lines in the road image are detected. The road image is processed by the second network, and the lane lines in the road image are obtained, i.e., the multiple lanes are obtained. In other embodiments, other image detection solutions may also be adopted to detect the multiple lanes in the road image. In some possible implementations, firstly, greyscale processing is performed on the road image, and edge detection is performed on the lane edges in the road image, which has been subjected to the greyscale processing, by, for example, an edge detection operator. Binarization processing is then performed on the processed image to obtain the lane lines in the road image.

In a second operation, respective ends of the multiple lanes are connected to obtain the multiple road boundaries.

In some embodiments, the multiple road boundaries associated with the vehicle are obtained by connecting respective end edges of the lane lines of the lanes. For example, a boundary of a road perpendicular to the road where the vehicle is located may be obtained by connecting end edges under the vehicle on the left and right sides of the vehicle. In this way, the multiple road boundaries in the road image may be identified more concisely by connecting the respective end edges of the lanes.

In a third manner, the operation that a freespace of the road where the vehicle is located is determined by performing semantic segmentation on the road image may be implemented by the following operations.

In a first operation, semantic segmentation is performed on the road image to obtain a freespace in the road image.

In some embodiments, a third network is used to perform the semantic segmentation on the road image to obtain the freespace of the road in the road image. The third network may be a neural network for performing semantic segmentation, for example, a full convolutional neural network, a Mask Region Convolutional Neural Network (Mask R-CNN), or the like. The freespace in the road image is detected by the third network. The freespace, which may also be referred to as a reachable region, indicates a region in which a vehicle may drive. In the road image, in addition to the current vehicle, generally, other vehicles, pedestrians, trees, road edges, or the like are included. For example, regions in which other vehicles, pedestrians, trees, and road edges are located are regions in which the current vehicle cannot drive. Therefore, the semantic segmentation is performed on the road image by the third network to remove the regions in the road image in which, for example, other vehicles, pedestrians, trees, and road edges are located, and the freespace of the vehicle is obtained.

In a second operation, the multiple road boundaries are determined based on a contour line of the freespace.

In some embodiments, a road boundary of the road where the freespace is located is obtained by identifying the contour line of the freespace. For example, the contour line of the freespace is regarded as the road boundary of the road where the freespace is located. In this way, the multiple road boundaries in the road image may be precisely identified by segmenting the freespace of the road in the road image.

In some embodiments, by identifying road information of the road associated with the vehicle, or by analyzing the relationship between the road boundary and the vehicle, the target road boundary dangerous to the vehicle may be accurately selected from the multiple road boundaries. That is, the aforementioned operation S103 may be implemented in multiple manners as follows.

In a first manner, a road boundary adjacent to a lane where the vehicle is located is determined from the multiple road boundaries as the target road boundary.

In the first manner, the road boundary adjacent to the lane where the vehicle is located may be a road boundary bordering the lane where the vehicle is located. Since the road boundary bordering the lane where the vehicle is located is located in the blind area of the vehicle, the road boundary is invisible to the vehicle. That is, the road boundary is the target road boundary.

In a second manner, a road boundary having a distance less than a first preset distance from the vehicle is determined from the multiple road boundaries as the target road boundary.

In the second manner, the first preset distance may be set by measuring a blind area range of the vehicle. For example, the first preset distance is set to be less than or equal to the maximum diameter of the blind area range. The distance between the road boundary and the vehicle is a distance between each point on the road boundary and the vehicle. If a distance from a point to the vehicle is less than the first preset distance, it means that the point is invisible to the vehicle. In this way, by analyzing whether the distance between each of multiple points and the vehicle is less than the first preset distance, it may be determined whether the road boundary consisting of the multiple points is the target road boundary.

In some possible implementations, for any road boundary, points on the road boundary may be sampled at a certain length interval, and it may be determined whether the road boundary is the target road boundary by determining whether the distance between each of the sampling points and the vehicle is less than the first preset distance. For example, the first sampling point, which has a distance less than the first preset distance from the vehicle, is taken as a starting point, and the last sampling point, which has a distance less than the first preset distance from the vehicle, is taken as an end point. In this way, the road boundary between the starting point and the end point is the target road boundary.

In a third manner, a road boundary having a road space less than a preset space from the vehicle is determined from the multiple road boundaries as the target road boundary.

In the third manner, the road space between the road boundary and the vehicle may be the width of the road region between the vehicle and the road boundary. The preset space may be determined based on the width of the lane and the width of the vehicle capable of driving on the lane. For example, the preset space is set to be greater than the width of the vehicle capable of driving on the lane, and less than the width of the lane. If the width between the road boundary and the vehicle is less than the preset space, it indicates that an oncoming vehicle cannot drive between the road boundary and the vehicle. That is, the space between the road boundary and the vehicle is small, which indicates that the road boundary may be dangerous to normal driving of the vehicle. Thus, such road boundary is taken as the target road boundary. If the width between the road boundary and the vehicle is greater than or equal to the preset space, it indicates that an oncoming vehicle may still drive between the road boundary and the vehicle. That is, there is sufficient space between the road boundary and the vehicle, which indicates that the road boundary is not dangerous to the normal driving of the vehicle. Thus, such road boundary is not taken as the target road boundary.

In the fourth manner, the target road boundary dangerous to the vehicle is determined from the multiple road boundaries based on road information determined by the road image.

In the fourth manner, road information of the road where the vehicle is located in the road image may be identified by performing image detection on the road image. The target road boundary dangerous to the vehicle is identified from the multiple road boundaries based on the road information. The road information of the road associated with the vehicle is used to represent multiple types of information that may be detected on the road. For example, the road information includes at least one of a road surface signal, a lane line, a stop line region, a turning sign, or obstacle information in the road image. The turning sign may be located on a turning edge of the road. The target road boundary dangerous to the vehicle may be accurately detected by comprehensively taking into account multiple types of information on the road surface.

In some possible implementations, the road information may be acquired by the following operations.

In a first operation, a road surface signal of the road associated with the vehicle in the road image is determined.

In some embodiments, image feature extraction is performed on the road image by a detector in a deep neural network. Detection of the road surface signal in the road image may be implemented based on the extracted image features. The detected road surface signal includes multiple classes of road surface arrow information, for example, going straight, turning left, turning right, going straight and turning left, going straight and turning right, turning around, or, turning left, going straight and turning right.

In a second operation, a lane line of the road is segmented to obtain multiple lane lines.

In some embodiments, the lane line of the road is segmented by a semantic segmentation branch in the deep neural network to output multiple lane lines carrying class labels. Different classes of lane lines may be represented by different class labels, for example, the left lane line is represented as class 1, the right lane line is represented as class 2, the background is represented as class 0, and so on.

In a third operation, a stop line of the road is detected to obtain a stop line region.

In some embodiments, two-class segmentation is performed on the stop line of the road by a stop line segmentation branch in the deep neural network. The obtained segmentation result is that the stop line region is represented as 1 and the background region is represented as 0, so as to implement the segmentation of the stop line.

In a fourth operation, intersection turning signs of the road are identified to obtain multiple classes of turning signs.

In some embodiments, semantic segmentation is performed on the intersection turning signs of the road by an intersection turning output branch in the deep neural network, to obtain the multiple classes of turning signs. For example, 3 classes are defined for the turning signs in an order from left to right, which may sequentially be class 1 for a left turning sign, class 2 for a forward turning sign, and class 3 for a right turning sign. The class of the background is 0.

In a fifth operation, an obstacle on the road is detected to obtain object information of the obstacle.

In some embodiments, the obstacle on the road is detected by an obstacle detection branch in the deep neural network. The obstacle is taken as the foreground of target detection, and a non-obstacle is taken as the background. The obstacle may be all objects or pedestrians other than the vehicle. The obstacle information includes the position, size information, or the like, of the obstacle.

The aforementioned first to fifth operations may be performed simultaneously by different branches in the same network.

In a sixth operation, at least one of the road surface signal, the multiple lane lines, the stop line region, the multiple classes of turning signs, and the object information is determined as the road information.

In the sixth operation, the road surface sign information, the lane line information, the intersection turning information, and so on, which are obtained in the aforementioned first to fifth operations, are taken as the road information. In this way, detection tasks of the road surface signal, the lane line and the intersection turning are fused into the same deep learning network for joint learning, so as to obtain the output road information, which makes the road information rich in content, and thus rich information may be provided for the vehicle, such that the vehicle may generate an effective control signal.

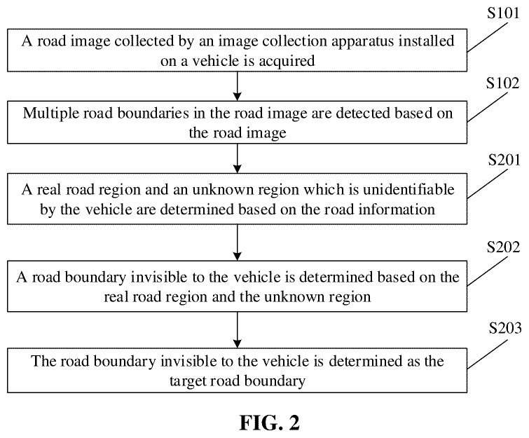

In some possible implementations, a real road region and an unknown region may be identified by analyzing the road information, and thereby a road boundary invisible to the vehicle may be detected. FIG. 2 is another schematic implementation flowchart of an image processing method provided by an embodiment of the disclosure. As shown in FIG. 2, illustration is performed in combination with operations shown in FIG. 2.

In operation S201, a real road region and an unknown region which is unidentifiable by the vehicle are determined based on the road information.

In some embodiments, the real road region of the road may be obtained by analyzing the road surface signal, the multiple lane lines, the stop line region, the multiple classes of turning signs, and the object information in the road information. For example, in case that there are no objects or pedestrians on the road, the road surface region of the road is taken as the real road region. The unknown region unidentifiable by the vehicle may be a region on the road or a region outside the road. For example, the unknown region may be a region in the blind area of the vehicle, a region obscured by an obstacle, a region unidentifiable by the vehicle due to a long distance, or the like.

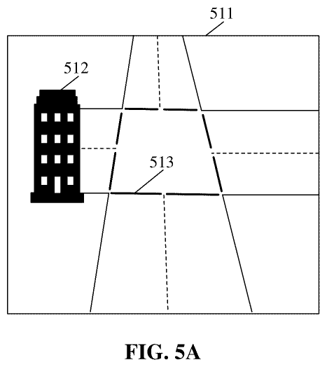

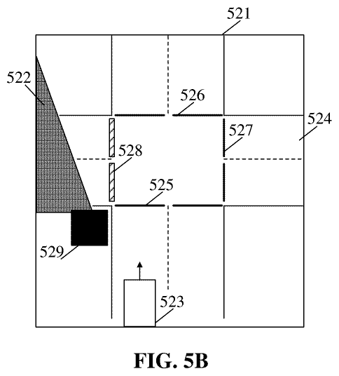

For example, in an intersection scenario shown in FIG. 5A and FIG. 5B, there is a building at the southwest corner of the intersection (the top, bottom, left and right of the image correspond to the north, south, west and east respectively). Generally, the building obscures a view of a vehicle driving from the south to the north, as shown in FIG. 5B, such that the driver or sensor in the vehicle cannot obtain information of a part of the region that is obscured by the building. Such part of the region may be referred to as the unknown region, as shown in the region 522 in FIG. 5B. A road boundary, which cannot be sensed by the driver or sensor in the vehicle because of being obscured by the building or other reasons (e.g., too far away, etc.), is referred to as an invisible road boundary.

In operation S202, a road boundary invisible to the vehicle is determined based on the real road region and the unknown region.

In some embodiments, by converting the real road region and the unknown region from the current collection perspective into a bird's eye view, an overlapping road boundary of the two regions in the bird's eye view may be determined. In such case, the road boundary is the road boundary invisible to the vehicle.

In operation S203, the road boundary invisible to the vehicle is determined as the target road boundary.

In some embodiments, the road boundary invisible to the vehicle is the target road boundary that is not identified by the vehicle from the multiple road boundaries. In this way, the target road boundary may be precisely identified by comparing the real road region and the unknown region of the road associated with the vehicle.

A manner for determining the target road boundary is provided by the aforementioned operations S201 to S203, in which the road boundary invisible to the vehicle is taken as the target road boundary dangerous to the vehicle. In this way, potential danger to the vehicle may be effectively determined, and thus the driving safety of the autonomous vehicle may be improved.

In other implementations, the road boundary identifiable by the vehicle may further be analyzed to determine the target road boundary dangerous to the vehicle.

In some embodiments, both the real road region and the unknown region are converted into the bird's-eye view, and the road boundary invisible to the vehicle may be determined by analyzing the overlapping road boundary of the two regions in the bird's-eye view. That is, the aforementioned operation S202 may be implemented by the following operations S221 to S223 (not shown in the drawings).

In operation S221, a collection viewpoint of the real road region and a collection viewpoint of the unknown region are converted into a bird's eye view, to obtain a converted real road region and a converted unknown region.

In some embodiments, the real road region and the unknown region are converted into the bird's eye view respectively by a single response matrix, and the converted real road region and the converted unknown region in the bird's eye view are obtained. In this way, road information in the real road region, for example, the road surface signal, the multiple lane lines, the stop line region, the multiple classes of turning signs, and the object information in the real road region, are also all converted into the road surface signal, the multiple lane lines, the stop line region, the multiple classes of turning signs, and the object information in the bird's eye view. For example, a position of the object information in the real road region is converted into a position in the converted road region in the bird's eye view. Similarly, the road information in the unknown region is simultaneously converted into road information in the bird's eye view.

In operation S222, an overlapping region of the converted real road region and the converted unknown region is determined.

In some embodiments, the road information in the converted real road region in the bird's eye view is fitted, and the road information in the converted unknown region is fitted. An overlapping part, i.e., the overlapping region between the two regions may be determined based on the fitted information.

In operation S223, a road boundary in the overlapping region is determined as the road boundary invisible to the vehicle.

In some embodiments, since the unknown region is a region unidentifiable by the vehicle, the converted unknown region is still a region unidentifiable by the vehicle. Based on this, the overlapping region between the converted real road region and the converted unknown region is a real road region unidentifiable by the vehicle, and it is apparent that the road boundary in the region is also unidentifiable by the vehicle, which is the target road boundary.

In the embodiments of the disclosure, the road boundary invisible to the vehicle may be effectively identified with fewer network resources by analyzing the overlapping region between the converted real road region and the converted unknown region in the bird's eye view, which facilitates the subsequent planning of the driving path of the vehicle.

In some embodiments, the road information in the converted real road region in the bird's-eye view and the road information in the converted unknown region in the bird's-eye view are fitted. The overlapping road boundary of the two regions may be obtained according to the fitting result. That is, the aforementioned operation S222 may be implemented by the following operations.

In a first operation, multiple lane lines, a stop line region and a turning sign in the converted real road region are fitted to obtain first fitting information.

In some embodiments, the multiple lane lines, the stop line region and the multiple classes of turning signs in the converted real road region are fitted by means of matrix transformation to obtain the first fitting information. The first fitting information includes the fitted lane lines, stop line region and multiple classes of turning signs in the converted real road region.

In a second operation, a lane line, a stop line region and a turning sign in the converted unknown region are fitted to obtain second fitting information.

In some embodiments, the multiple lane lines, the stop line region and the multiple classes of turning signs in the converted unknown region are fitted by means of the matrix transformation to obtain the second fitting information. The second fitting information includes the fitted lane lines, stop line region and multiple classes of turning signs in the converted unknown region.

In a third operation, the overlapping region between the converted real road region and the converted unknown region is determined based on the first fitting information and the second fitting information.

In some embodiments, an overlapping lane line, stop line region, and turning sign of the two regions may be determined according to the fitted lane lines, stop line region and multiple classes of turning signs in the converted real road region, and the fitted lane lines, stop line region and multiple classes of turning signs in the converted unknown region. The overlapping region between the two regions may then be obtained.

In the embodiments of the disclosure, the fitting result of various road information may be obtained by fitting the road information in different regions in the bird's-eye view. In this way, the target road boundary within the overlapping region may be determined more accurately by comprehensively taking into account multiple types of information on the road.

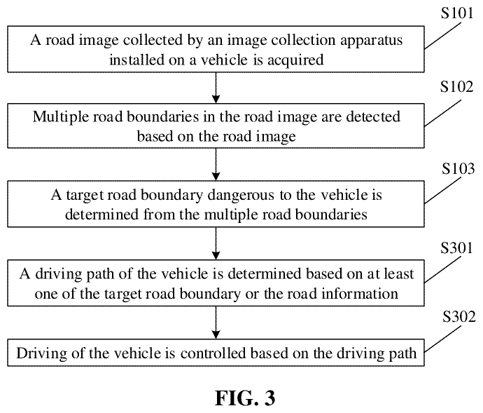

In some embodiments, after the target road boundary dangerous to the vehicle is identified, a driving path for controlling the driving of the vehicle is generated by analyzing at least one of the target road boundary or the road information, such that the autonomous driving of the vehicle is controlled. That is, after the operation S103, the method further includes operations shown in FIG. 3. Illustration is performed as follows in combination with FIG. 3.

In operation S301, a driving path of the vehicle is determined based on at least one of the target road boundary or the road information.

In some embodiments, the driving path of the vehicle may be determined based on the target road boundary to control the driving of the vehicle. The driving path of the vehicle may be determined based on the road information to control the driving of the vehicle. The driving path of the vehicle may further be determined based on a combination of the target road boundary and the road information to jointly control the driving of the vehicle. The driving path of the vehicle may be generated by analyzing the target road boundary to remind the vehicle of the position of the target road boundary, such that the vehicle is controlled to be away from the target road boundary and thus possible danger during the driving process of the vehicle is reduced. Alternatively, a driving path of the vehicle at a future moment is predicted by analyzing the road information of the road where the vehicle is located, i.e., the road surface signal, the multiple lane lines, the stop line region, the multiple classes of turning signs, and the object information of the road where the vehicle is located, or the like, such that the driving of the vehicle is controlled. Alternatively, the target road boundary and the road information are combined to generate a more precise driving path, such that the driving of the vehicle is controlled more accurately.

The driving path is a path plan for the vehicle to drive at a future moment, which includes the driving direction, the driving speed, the driving path, or the like, of the vehicle. The driving path of the vehicle may be determined based on the target road boundary, or the driving path of the vehicle may be further determined based on the road information, or the driving path of the vehicle may be further determined by combining the target road boundary and the road information.

In some possible implementations, the aforementioned operation that the driving path of the vehicle is determined based on the road information may be implemented by the following operations.

In a first operation, a driving intention of the vehicle is determined based on the road information.

In some embodiments, the driving intention of the vehicle is determined based on at least a part of the road information. For example, the driving intention of the vehicle is determined based on the multiple lane lines, the stop line region, and the multiple classes of turning signs. The driving intention is used to represent a driving manner of the vehicle in an upcoming future period, for example, the driving speed and driving direction in the next one minute, or the like.

In a second operation, the driving path of the vehicle is determined based on the driving intention.

In some embodiments, a driving path of the vehicle during a preset future period is specified according to the driving intention of the vehicle during the preset future period, and the driving path is obtained. For example, if the driving intention is to drive straight, a path of driving straight of the vehicle during the preset period is formulated.

In operation S302, the driving of the vehicle is controlled based on the driving path.

In some embodiments, the electronic device may determine the driving path of the vehicle with respect to a road boundary into which the vehicle may drive, and then control the vehicle to drive according to the driving path. In this way, effective control of the vehicle is implemented by comprehensively taking into account the target road boundary and the road information.

In some embodiments, the operation that the driving path of the vehicle is determined based on the road information in the aforementioned operation S301 may be implemented by the following operations S311 and S312 (not shown in the drawings).

In the operation S311, a turning orientation and a turning position of the vehicle are determined based on the road surface signal and the turning sign in the road information.

In some embodiments, according to the road surface signal in the road information, it may be determined that the turning sign of the vehicle is which one of going straight, turning left, turning right, going straight and turning left, going straight and turning right, turning around, or, turning left, going straight and turning right. The turning position indicates an inflection point at which the vehicle enters the turning lane when turning. The turning orientation indicates a direction in which the vehicle is driving when turning from the current position into the turning lane. In this way, the turning orientation may be a driving direction that is continuously provided for the vehicle during the turning process.

In the operation S312, a turning driving path of the vehicle is determined based on the turning orientation and the turning position.

In some embodiments, the driving path of the vehicle performing turning is predicted according to the driving direction of the vehicle when turning which is indicated by the turning orientation, and the inflection point of the vehicle when turning. Thus, the vehicle may implement a correct turning based on the turning driving path. In this way, the turning orientation and turning position of the vehicle at a future moment may be accurately predicted according to the road surface signal in the road information, such that turning of the vehicle may be precisely controlled.

In the aforementioned operations S311 and S312, the road surface signal and turning sign in the road information are acquired by the road information, and the driving path of the vehicle is generated according to the road surface signal and turning sign, which may thus improve the accuracy of the driving path.

In some embodiments, updating of the driving path is implemented by detecting the obstacle information in the road image, and thereby the driving of the vehicle is effectively controlled. That is, the aforementioned operation S302 may be implemented by the following operations S321 and 322 (not shown in the drawings).

In the operation S321, the driving path is updated based on the obstacle information in the road information, to obtain an updated path.

In some embodiments, if the object information of the obstacle exists in the road information, i.e., there is an obstacle on the road, the generated driving path is updated according to the object information of the obstacle in the road information. For example, a path in the original driving path, which passes the position of the obstacle, is updated according to the position information and size information of the obstacle, such that the updated path avoids the obstacle.

In the operation S322, the driving of the vehicle is controlled based on the updated path.

In some embodiments, the vehicle is controlled to drive according to the updated path, such that the vehicle may avoid obstacles during the driving process and the driving safety of the vehicle may be improved.

In the aforementioned operations S321 and S322, the driving path is updated by combining the position information of the obstacle in the road information, such that the driving of the vehicle is controlled according to the updated path, which may then provide more information for the autonomous vehicle when making decisions.

In the embodiments of the disclosure, after the target road boundary is identified, a subsequent driving path is generated by combining rich road information. In this way, the generated driving path is more accurate, and based on this, precise control of the vehicle may be implemented by the driving path.

In some embodiments, a map of the position of the vehicle is updated by analyzing the target road boundary, and thus the driving path of the vehicle is generated. That is, the operation that the driving path of the vehicle is determined based on the target road boundary in the aforementioned operation S301 may be implemented by the following operations.

In a first operation, map data of the position of the vehicle is updated based on the target road boundary, to obtain an updated map.

In some embodiments, the map data of the position of the vehicle is acquired. The map data may be a third party map, or road information and traffic signs (e.g., traffic sign lights, traffic signboards, etc.) collected by a positioning system in an in-vehicle device, or the like. The target road boundary is marked in the map data of the position of the vehicle, and the updated map is obtained. In this way, the updated map carries the target road boundary, and may remind the vehicle which positions have invisible road boundaries.

In a second operation, the driving path of the vehicle is determined based on the updated map.

In some embodiments, a driving path away from the target road boundary is formulated according to the target road boundary marked in the updated map, such that the vehicle will not touch the target road boundary when driving according to the driving path.

In the embodiments of the disclosure, a map taking into account road danger is made according to the detected target road boundary, and thus the driving path for controlling the driving of the vehicle is generated according to the updated map, which improves the safety of the driving path.

In some embodiments, the operation that after the target road boundary is identified, the driving of the vehicle is effectively controlled by analyzing the relationship between the target road boundary and a driving state may be implemented by the following process.

The vehicle is controlled based on the relationship between the target road boundary and the driving state of the vehicle.

The relationship between the target road boundary and the driving state of the vehicle is used to indicate an effect of the target road boundary on the driving state, which includes the included angle between the target road boundary and the driving direction of the vehicle, the distance between the target road boundary and the lane where the driving vehicle is located, or the like.

In some possible implementations, after the target road boundary is identified, the vehicle may be controlled to be in a brake state. That is, the operation that the vehicle is controlled may be an operation that the vehicle is controlled to enter the brake state from a driving state, or an operation that the vehicle is controlled to drive away from the target road boundary.

In this way, after the target road boundary is determined, brake indicative information is generated to enable the vehicle to enter the brake state. In this way, in case that the target road boundary is identified, the vehicle is controlled to prepare for brake, which may improve the driving safety of the vehicle. The electronic device generates the brake indicative information after the target road boundary is determined, and feeds the brake indicative information back to the autonomous driving system of the vehicle. In response to the brake indicative information, the autonomous driving system of the vehicle controls the vehicle to enter the brake state. In case that it is determined that a danger occurs, the vehicle may be controlled to enter the brake state from the driving state, or the vehicle may be controlled to drive away from the target road boundary. For example, after the target road boundary is identified, the vehicle is controlled to enter the brake state from the driving state, or the vehicle is controlled to drive away from the target road boundary. In this way, after the target road boundary is detected, the vehicle is controlled to enter the brake state by generating the brake indicative information, thereby improving the driving safety of the vehicle.

In some possible implementations, the relationship between the target road boundary and the driving state of the vehicle includes at least one of the following multiple cases.

In a first case, the relationship between the target road boundary and the driving state of the vehicle may be a case where a distance, which is between an overlapping region where the target road boundary is located and a road intersection ahead of the vehicle, is less than a second preset distance.

The intersection along the driving direction of the vehicle of the lane where the vehicle is located is the intersection ahead of the lane where the vehicle is located. The distance between the intersection and the overlapping region may be the minimum distance between the intersection and the overlapping region, or may be an average of the maximum distance and the minimum distance between the intersection and the overlapping region. The second preset distance may be the same as or different from the first preset distance. The second preset distance may be set based on the blind area range of the measured vehicle, or may be autonomously set by the user. If the distance between the intersection and the overlapping region is less than the second preset distance, it means that the invisible overlapping region may affect the vehicle passing the intersection. Therefore, in order to improve the driving safety of the vehicle, the brake indicative information for controlling the vehicle to enter the brake state is generated.

In a second case, the relationship between the target road boundary and the driving state of the vehicle may be a case where a distance between the overlapping region and the position of the vehicle is less than a third preset distance.

In some embodiments, the distance between the overlapping region and the position of the vehicle may be the minimum distance between the overlapping region and the position of the vehicle, or may be an average of the maximum distance and the minimum distance between the overlapping region and the position of the vehicle. The third preset distance may be a distance between the position of the vehicle and the road edge in case that the vehicle is normally driving. If the distance between the overlapping region and the position of the vehicle is less than the third preset distance, it means that the overlapping region will affect the normal driving of the vehicle. Therefore, in order to improve the driving safety of the vehicle, the brake indicative information for controlling the vehicle to enter the brake state is generated.

In a third case, the relationship between the target road boundary and the driving state of the vehicle may be a case where an included angle between the driving direction of the vehicle and the target road boundary is less than a preset angle.

The preset angle may be set based on the minimum included angle between the driving direction and the road boundary in case that the vehicle is normally driving. For example, the preset angle is the minimum included angle between the driving direction of the vehicle and the road boundary under the premise that the vehicle may normally turn. If the included angle between the driving direction of the vehicle and the target road boundary is less than the preset angle, it means that the target road boundary will affect the normal driving of the vehicle. In such case, the vehicle is controlled to enter the brake state from the driving state, or the vehicle is controlled to drive away from the target road boundary, which may improve the driving safety of the vehicle.

In a fourth case, the relationship between the target road boundary and the driving state of the vehicle may be a case where the target road boundary is connected with the lane where the vehicle is located.

If the target road boundary is connected with the lane where the vehicle is located, the vehicle will touch the target road boundary if it continues to drive in the lane according to the current driving direction. Since risk of the target road boundary is unpredictable, in case that the target road boundary is connected with the lane where the vehicle is located, the vehicle is controlled to enter the brake state from the driving state, or the vehicle is controlled to drive away from the target road boundary, which may effectively reduce potential danger of the driving of the vehicle.

In the embodiments of the disclosure, the relationship between the target road boundary and the driving state of the vehicle is analyzed. If the target road boundary will affect the normal driving of the vehicle, the brake indicative information for controlling the vehicle to enter the brake state is generated, or the vehicle is controlled to be away from the target road boundary, which may further improve the driving safety of the vehicle.

In some embodiments, the operation that after the target road boundary is determined, object identification may be performed more accurately in a region of interest by obtaining the region of interest and the road image according to different resolutions or frame rates may be implemented in the following manners.

In a first manner, the region of interest is set based on the target road boundary, and an image corresponding to the region of interest is obtained based on a first resolution.

In the first manner, the road image is obtained according to a second resolution, and the second resolution is less than the first resolution.

In a second manner, the image corresponding to the region of interest is obtained based on a first frame rate.

In the second manner, the road image is obtained based on a second frame rate, and the second frame rate is less than the first frame rate.

The electronic device sets a Region of Interest (ROI) based on the road boundary into which the vehicle may drive. For the road environment, the electronic device may obtain the road image with the second resolution (which may also be referred to as a low resolution), and for the region of interest, the electronic device may obtain the road image with the first resolution (which may also be referred to as a high resolution) that is higher than the second resolution. In this way, an image with a higher quality is collected for the region of interest, which facilitates performing subsequent object identification on the image corresponding to the region of interest.

Alternatively, for the road environment, the electronic device may obtain the road image with the second frame rate (which may also be referred to as a low frame rate), and for the region of interest, the electronic device may obtain the road image with the first frame rate (which may also be referred to as a high frame rate) that is higher than the second frame rate, which facilitates performing subsequent object identification on the image corresponding to the region of interest.

In some embodiments, the operation that after it is detected that the vehicle drives away from the target road boundary, notification information of danger prediction is sent to a rear vehicle of the vehicle to remind the rear vehicle of the target road boundary may be implemented by the following process.

Firstly, road environment information around the target road boundary is collected.

In some embodiments, the road environment information around the target road boundary is collected in case that it is detected that the vehicle drives away from the target road boundary. Since the target road boundary is invisible, possible risk of the target road boundary is unpredictable by the vehicle. Therefore, after it is detected that the vehicle passes the target road boundary, the camera in the vehicle may identify the target road boundary, and the road environment information around the target road boundary is collected by the camera. The road environment information includes the length, position, obstacle information, road surface signals, or the like, of the target road boundary.

Secondly, notification information is generated based on the road environment information.

In some embodiments, the road environment information based on the target road boundary is carried in the notification information, and the notification information is sent to the rear vehicle of the vehicle.

Finally, the notification information is sent to the rear vehicle of the vehicle.

In some embodiments, the notification information carrying the road environment information is sent to an autonomous driving system of the rear vehicle, or to a terminal communicating with the autonomous driving system, such that the rear vehicle may formulate a suitable driving path based on the road environment information in the notification information.

In the embodiments of the disclosure, after it is detected that the vehicle passes the target road boundary, the road environment information around the target road boundary is sent to the rear vehicle in the form of notification information, so as to timely remind the rear vehicle of the existence of the target road boundary ahead, such that the rear vehicle may timely adjust the driving path.

In the following, an exemplary application of an embodiment of the disclosure in a practical application scenario will be illustrated, taking a case where the deep neural network is adopted for road surface signs to determine the turning of the vehicle at a road intersection as an example.

Autonomous driving is a whole system, and the output of the sensing module is for the purpose of serving the subsequent module. For example, the sensing result is not only to provide whether a certain object exists ahead, but also needs to provide relevant logic output for the subsequent module, and to provide certain control signals and logic signals for the autonomous driving. However, sensing modules on the market do not effectively combine all the sensing information, which introduces many problems in the application. That is, the purpose of sensing is only to determine the existence of a target, without caring about credibility and accuracy of the subsequent control signals.

Based on this, an embodiment of the disclosure provides a road intersection turning selection solution based on road surface signs. In other words, road surface sign information, lane line information, intersection turning information, or the like, are adopted to provide an effective autonomous driving signal for a downstream module.

An embodiment of the disclosure provides an image processing method. Road sensing information is obtained by detecting a road boundary, and the obtained road sensing information is converted into a bird's-eye view. The road sensing information in the bird's-eye view is combined to determine turning at a road intersection. The method may be implemented by the following operations.

In a first operation, in a road image, a road boundary is detected to extract road sensing information of the road.

In some embodiments, road boundary detection may be implemented in the following two manners.

In a first manner, the road boundary is directly detected by a detection model, which may be implemented by the following process.

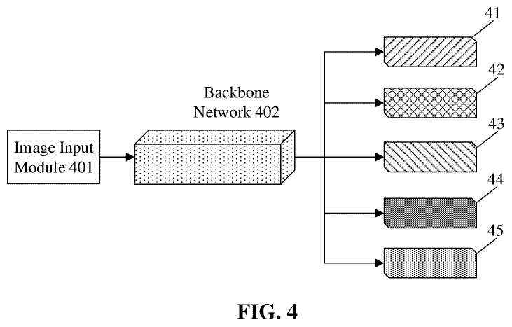

During an autonomous driving process, a vehicle needs to perform sensing output according to information provided on the road, and perform information integration on the result output by the model. FIG. 4 is a network structure diagram of an image processing method provided by an embodiment of the disclosure. As shown in FIG. 4, the network architecture includes an image input module 401, a backbone network 402, a road surface signal detection branch network 41, a lane line segmentation branch network 42, a stop line segmentation branch network 43, an intersection turning output branch network 44, and an obstacle detection output branch network 45.

The image input module 401 is configured to input the road image.

The backbone network 402 is configured to perform feature extraction on the input road image.

The backbone network may be a VGG network, a GoogleNet network, a residual network (ResNet) network, or the like.

The road surface signal detection branch network 41 is configured to perform a detection task, and to perform road surface signal detection based on the extracted image features.

The road surface signal detection branch network 41 may be implemented by a detector, for example, a two-stage detector or an one-stage detector. The road surface signal detection branch network 41 may be a classification branch for classifying the detected road surface signals. The classes include going straight, turning left, turning right, going straight and turning left, going straight and turning right, turning around, or, turning left, going straight and turning right, or the like.

The lane line segmentation branch network 42 is configured to segment a lane line in the road image based on the extracted image features.

Taking a lane line annotation of “three lanes and four lines” as an example, the annotated labels include the left lane line of the lane where the ego vehicle is located (i.e., the left lane line), the left lane line of the left lane of the lane where the ego vehicle is located (i.e., the left and left lane line), the right lane line of the lane where the ego vehicle is located (i.e., the right lane line), and the right lane line of the right lane of the lane where the ego vehicle is located (i.e., the right and right lane line). The lane line detection task is defined as semantic segmentation, i.e., the left and left lane line is class 1, the left lane line is class 2, the right lane line is class 3, the right and right lane line is class 4, and the background class is class 0.

The stop line segmentation branch network 43 is configured to segment a stop line in the road image based on the extracted image features.

Stop line detection may be performed by a two-class segmentation method, where the stop line region is set as 1 and the background class is set as 0.

The intersection turning output branch network 44 is configured to identify an intersection turning edge by the semantic segmentation.

The intersection turning is defined as 3 classes in an order from left to right, where the left turning edge is class 1, the forward turning edge is class 2, the right turning edge is class 3 in sequence, and the background class is 0.

The obstacle detection output branch network 45 is configured to identify an obstacle on the road surface by a detection method.

The obstacle on the road surface is identified by the obstacle detection output branch network 45. The obstacle is taken as the foreground of target detection, and a non-obstacle is taken as the background. As shown in FIG. 5A, in the collected in-vehicle camera image 511, the obstacle 512 and the road boundary 513 in the image 511 may be identified by performing the road boundary detection.

In a second manner, other road information is detected by the detection model and the road boundary is estimated based on the other road information. The other road information may be detected by the solution in the first manner.

There are two manners to estimate the road boundary based on the other road information as follows.
1. road ends are connected to determine the road boundary.
2. a freespace is determined by the semantic segmentation, and the road boundary is determined by the contour of the freespace.

In a second operation, the road boundary invisible to the ego vehicle is determined based on the road sensing information.

In some embodiments, the road boundary invisible to the ego vehicle may be determined by the following steps.

In a first step, road information is identified from an image collected by an in-vehicle camera.

The road information includes object information and lane lines on the road. The road information may be identified from the collected image by the network architecture shown in FIG. 4.

In a second step, an unknown region invisible to the ego vehicle is determined.

The unknown region may be a region obscured by an obstacle.

In a third step, a real road region is estimated based on the road information.

In a fourth step, the real road region and the unknown region are converted into a bird's eye view.

The image 511 in FIG. 5A may be converted into an image in the bird's eye view, such as the image 521 shown in FIG. 5B. In the image 521, the unknown region 522 is a region invisible to the ego vehicle 523, the real region 524 is a real road region, the boundary lines 525, 526 and 527 are road boundaries foreseeable by the ego vehicle 523, the boundary line 528 is a road boundary invisible to the ego vehicle 523, and there is the obstacle 529.

In a fifth step, if the real road region overlaps with the unknown region in the bird's eye view, the road boundary of the real region that overlaps with the unknown region is determined as the road boundary invisible to the ego vehicle.

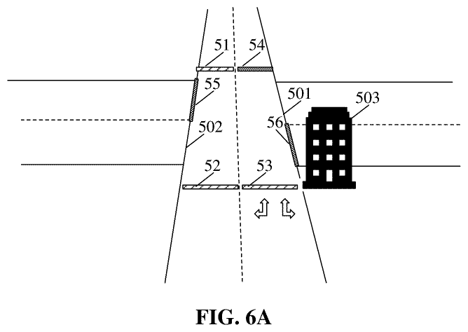

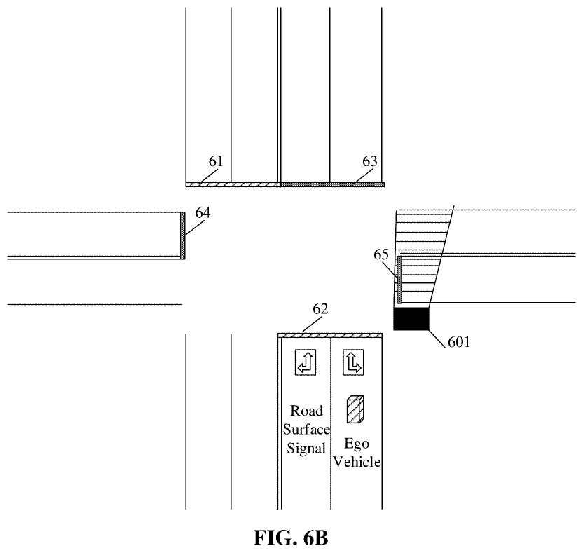

In some possible implementations, the road sensing information acquired in the first operation is converted into the bird's eye view by a single response matrix. That is, the road sensing information from the forward perspective of the ego vehicle is converted into the road sensing information in the bird's eye view by means of matrix transformation, and the road sensing information in the bird's eye view is fitted. That is, the lane lines, stop lines, turning edges, or the like in the bird's eye view are fitted to obtain a fitting result. FIG. 6A is a schematic diagram of an application scenario of an image processing method provided by an embodiment of the disclosure. As shown in FIG. 6A, the road sensing information from the forward perspective may be seen in FIG. 6A, i.e., the stop lines 51, 52 and 53, turning edges 54, 55 and 56, lane lines 501 and 502, and obstacle 503 from the forward perspective. The stop lines, turning edges, lane lines and obstacle are converted into the bird's eye view. As shown in FIG. 6B, the stop lines 51, 52 and 53 are converted into the stop lines 61 and 62 in the bird's eye view, the turning edges 54, 55 and 56 are converted into the turning edges 63, 64 and 65 in the bird's eye view, and the obstacle 503 is converted into the obstacle 601 in the bird's eye view.

It also can be seen in FIG. 6B that the ego vehicle 605 may detect semantic information according to the road surface signals, and thus it can be known that the ego vehicle may turn right. Therefore, a turning edge on the right will be selected, and a turning edge orientation and a turning position, or the like, may be obtained. A subsequent path planning is generated, and a control signal is sent to the ego vehicle for performing turning control. Similarly, the ego vehicle may generate other commands of going straight, such as turning left, going straight, or the like, according to the road surface signals, and may perform positioning matching with signals in the map to generate more stable signals. Furthermore, the ego vehicle takes into account position information of obstacles on the road. That is, if a turning edge is obscured by an obstacle, it will be fed back that the road boundary line in such direction cannot be accurately identified, thereby providing more information for the autonomous vehicle when making decisions.

In a third operation, a brake is prepared after the invisible road boundary is identified, and the vehicle is controlled to be away from the invisible road boundary.

In some possible implementations, after the overlapping region between the unknown region and the real road region is determined, the brake is prepared when the distance between the intersection and the overlapping region is within a preset range, or the distance between the unknown region unidentifiable by the ego vehicle and the overlapping region is within the preset range. The brake is prepared when the included angle between the driving direction of the ego vehicle and the invisible road boundary is less than a preset value. The brake is prepared when it is identified that the invisible road boundary touches the lane of the ego vehicle. In the invisible road boundary, the vehicle is controlled to be away from the road boundary touching the lane of the ego vehicle.

In the embodiment of the disclosure, the road surface signs, lane lines, and road intersection turning information are predicted by the deep neural network, and accurate road structure information and turning are obtained. According to the aforementioned sensing information, the sensing information from the forward perspective is converted into the bird's-eye view to determine the turning information of the vehicle at the road intersection. In this way, detection tasks of the road surface sign, the lane line, and the intersection turning are fused into the same deep learning network for joint learning to obtain the final sensing output, which provides effective signals for the subsequent direction control. In addition, multiple tasks are fused into a hybrid network for learning, which may effectively save network resources.

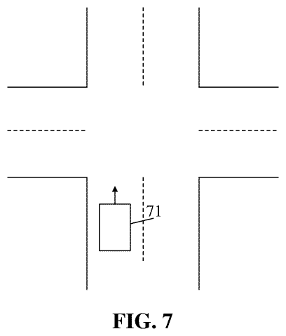

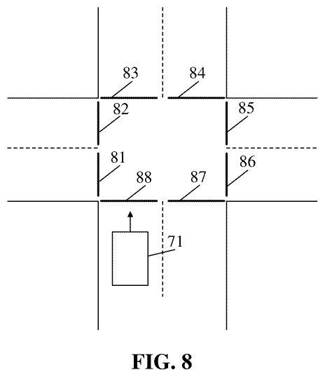

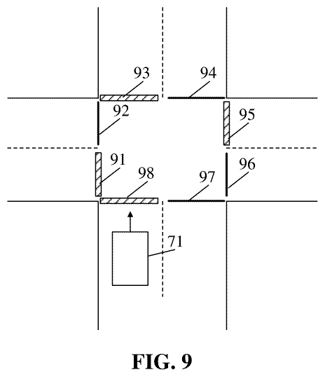

In the embodiment of the disclosure, when the vehicle is at an intersection, the vehicle may select a required road boundary by detecting multiple road boundaries. As shown in FIG. 7, when the vehicle 71 is at the intersection, the vehicle 71 selects a required road boundary by detecting multiple road boundaries. For example, if the vehicle 71 is driving on the left lane, the road boundary of the left lane is selected as a reachable lane. The road boundaries detected by the vehicle 71 are shown as FIG. 8, which includes the road boundaries 81 to 88. Reachable boundaries and unreachable boundaries are determined from the road boundaries 81 to 88. As shown in FIG. 9, the boundaries 91, 93, 95 and 98 are reachable boundaries, and the boundaries 92, 94, 96 and 97 are unreachable boundaries.

In the embodiment of the disclosure, whether the road boundary based on the obstacle detection is visible may provide richer planning and control information for the autonomous vehicle. In addition, from the perspective of model design and training, detection tasks of the road surface sign, the lane line, and the intersection turning are fused into the same deep learning network for joint learning to obtain the final sensing output, which may effectively save network resources, and may further provide effective signals for the subsequent vehicle control.

Those skilled in the art may understand that, in the aforementioned methods of the specific implementations, the written order of the operations does not imply a strict order of execution that constitutes any limitation on the implementation process. The specific order of execution of the operations is to be determined by their functions and possible internal logic.

Based on the same inventive concept, an embodiment of the disclosure further provides an image processing apparatus corresponding to the image processing method. Since the apparatus in the embodiment of the disclosure solves the problem in a similar principle as the aforementioned image processing method in the embodiment of the disclosure, implementation of the apparatus may be referred to the implementation of the method.

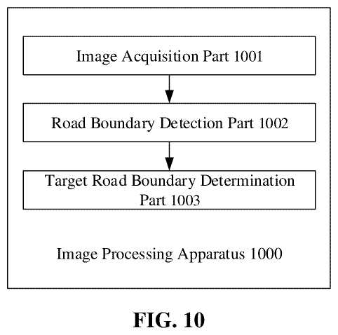

An embodiment of the disclosure provides an image processing apparatus. FIG. 10 is a schematic structure composition diagram of the image processing apparatus provided by the embodiment of the disclosure. As shown in FIG. 10, the image processing apparatus 1000 includes an image acquisition part 1001, a road boundary detection part 1002 and a target road boundary determination part 1003.

The image acquisition part 1001 is configured to acquire a road image collected by an image collection apparatus installed on a vehicle.

The road boundary detection part 1002 is configured to detect, based on the road image, multiple road boundaries in the road image.

The target road boundary determination part 1003 is configured to determine a target road boundary dangerous to the vehicle from the multiple road boundaries.

In some embodiments, the road boundary detection part 1002 is further configured to:
detect the road image to determine multiple road boundaries associated with the vehicle.

In some embodiments, the road boundary detection part 1002 includes a lane detection sub-part and a first road boundary determination sub-part.

The lane detection sub-part is configured to detect the road image to obtain multiple lanes in the road image.

The first road boundary determination sub-part is configured to connect respective ends of the multiple lanes to obtain the multiple road boundaries.

In some embodiments, the road boundary detection part 1002 includes a freespace segmentation sub-part and a second road boundary determination sub-part.

The freespace segmentation sub-part is configured to perform semantic segmentation on the road image to obtain a freespace in the road image.

The second road boundary determination sub-part is configured to determine the multiple road boundaries based on a contour line of the freespace.

In some embodiments, the target road boundary determination part 1003 includes at least one of a first target road boundary determination sub-part, a second target road boundary determination sub-part, a third target road boundary determination sub-part or a fourth target road boundary determination sub-part.

The first target road boundary determination sub-part is configured to determine from the multiple road boundaries, a road boundary adjacent to a lane where the vehicle is located, as the target road boundary.

The second target road boundary determination sub-part is configured to determine from the multiple road boundaries, a road boundary having a distance less than a first preset distance from the vehicle, as the target road boundary.

The third target road boundary determination sub-part is configured to determine from the multiple road boundaries, a road boundary having a road space less than a preset space from the vehicle, as the target road boundary.

The fourth target road boundary determination sub-part is configured to determine from the multiple road boundaries, the target road boundary dangerous to the vehicle, based on road information determined by the road image. The road information includes at least one of a road surface signal, a lane line, a stop line region, a turning sign, or obstacle information in the road image.

In some embodiments, the fourth target road boundary determination sub-part includes an unknown road region determination part, a road boundary determination part and a target road boundary determination part.

The unknown road region determination part is configured to determine, based on the road information, a real road region and an unknown region which is unidentifiable by the vehicle.

The road boundary determination part is configured to determine, based on the real road region and the unknown region, a road boundary invisible to the vehicle.

The target road boundary determination part is configured to determine the road boundary invisible to the vehicle as the target road boundary.

In some embodiments, the road boundary determination unit includes a region perspective conversion sub-part, an overlapping region determination sub-part and a road boundary determination sub-part.

The region perspective conversion sub-part is configured to convert a collection viewpoint of the real road region and a collection viewpoint of the unknown region into a bird's eye view, to obtain a converted real road region and a converted unknown region.

The overlapping region determination sub-part is configured to determine an overlapping region of the converted real road region and the converted unknown region.

The road boundary determination sub-part is configured to determine a road boundary in the overlapping region as the road boundary invisible to the vehicle.

In some embodiments, the overlapping region determination sub-part is further configured to: fit a lane line, a stop line region and a turning sign in the converted real road region to obtain first fitting information; fit a lane line, a stop line region and a turning sign in the converted unknown region to obtain second fitting information; and determine, based on the first fitting information and the second fitting information, the overlapping region between the converted real road region and the converted unknown region.

In some embodiments, the apparatus further includes a driving path determination part and a vehicle driving control part.

The driving path determination part is configured to determine a driving path of the vehicle based on at least one of the target road boundary or the road information.

The vehicle driving control part is configured to control driving of the vehicle based on the driving path.

In some embodiments, the driving path determination module includes a turning determination sub-part and a turning driving path determination sub-part.

The turning determination sub-part is configured to determine a turning orientation and a turning position of the vehicle based on the road surface signal and the turning sign in the road information.

The turning driving path determination sub-part is configured to determine the driving path of the vehicle based on the turning orientation and the turning position.

In some embodiments, the vehicle driving control module includes a driving path updating sub-part and a vehicle driving control sub-part.

The driving path updating sub-part is configured to update the driving path based on object information of an obstacle in the second road information, to obtain an updated path.

The vehicle driving control sub-part is configured to control the driving of the vehicle based on the updated path.

In some embodiments, the driving path determination module includes a map data updating sub-part and a driving path determination sub-part.

The map data updating sub-part is configured to update map data of a position of the vehicle based on the target road boundary, to obtain an updated map.

The driving path determination sub-part is configured to determine the driving path of the vehicle based on the updated map.

In some embodiments, the apparatus further includes a vehicle control part.

The vehicle control part is configured to control the vehicle based on a relationship between the target road boundary and a driving state of the vehicle.

In some embodiments, the relationship between the target road boundary and the driving state of the vehicle includes at least one of:
a case where a distance, which is between an overlapping region where the target road boundary is located and a road intersection ahead of the vehicle, is less than a second preset distance;
a case where a distance between the overlapping region and the position of the vehicle is less than a third preset distance;
a case where an included angle between a driving direction of the vehicle and the target road boundary is less than a preset angle; or
a case where the target road boundary is connected with the lane where the vehicle is located.

In some embodiments, the vehicle control module is further configured to control the vehicle to enter a brake state from a driving state, or control the vehicle to drive away from the target road boundary.

In some embodiments, the apparatus further includes at least one of a first region of interest determination part or a second region of interest determination part.

The first region of interest determination part is configured to set a region of interest based on the target road boundary, and obtain an image corresponding to the region of interest based on a first resolution. The road image is obtained according to a second resolution, and the second resolution is less than the first resolution.

The second region of interest determination part is configured to obtain the image corresponding to the region of interest based on a first frame rate. The road image is obtained based on a second frame rate, and the second frame rate is less than the first frame rate.

In some embodiments, the apparatus further includes a road environment information collection part, a notification information generation part and a notification information part.

The road environment information collection part is configured to collect road environment information around the target road boundary.

The notification information generation part is configured to generate notification information based on the road environment information.

The notification information part is configured to send the notification information to a rear vehicle of the vehicle. The rear vehicle and the vehicle are located in the same lane and have the same driving direction.

It is to be noted that the description of the aforementioned apparatus embodiments is similar to the description of the aforementioned method embodiments, and the apparatus embodiments have similar beneficial effects as the method embodiments. For technical details that are not disclosed in the apparatus embodiments of the disclosure, please refer to the description of the method embodiments of the disclosure for understanding.

In the embodiments of the disclosure as well as other embodiments, a “module” may be a circuit, a processor, a program, software, or the like, and of course may be a unit, and may be non-modular.

It is to be noted that, in the embodiments of the disclosure, when the aforementioned image processing method is implemented in the form of a software functional module and sold or used as an independent product, it may also be stored in a computer-readable storage medium. Based on such understanding, the technical solutions of the embodiments of the disclosure substantially or parts making contributions to the related art may be embodied in the form of a software product. The computer software product is stored in a storage medium, including several instructions for enabling a computer device (which may be a terminal, a server, or the like) to perform all or part of the methods described in various embodiments of the disclosure. The aforementioned storage medium includes various media capable of storing program codes, such as a USB disk, a mobile hard disk, a Read Only Memory (ROM), a magnetic disk, an optical disk, or the like. In this way, the embodiments of the disclosure are not limited to any particular combination of hardware and software.

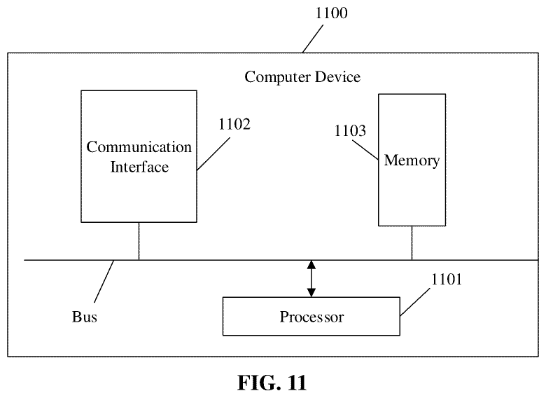

Correspondingly, an embodiment of the disclosure further provides a computer program product including computer-executable instructions. The computer-executable instructions, when executed, may implement the operations of the image processing method provided by the embodiments of the disclosure. Correspondingly, an embodiment of the disclosure further provides a computer storage medium having stored thereon computer-executable instructions. The computer-executable instructions, when executed by a processor, implement the operations of the image processing method provided by the aforementioned embodiments. Correspondingly, an embodiment of the disclosure provides a computer device. FIG. 11 is a schematic composition structure diagram of the computer device provided by the embodiment of the disclosure. As shown in FIG. 11, the computer device 1100 includes a processor 1101, at least one communication bus, a communication interface 1102, at least one external communication interface, and a memory 1103. The communication interface 1102 is configured to implement connection communication between these components. The communication interface 1102 may include a display, and the external communication interface may include a standard wired interface and a standard wireless interface. The processor 1101 is configured to execute an image processing program in the memory to implement the operations of the image processing method provided by the aforementioned embodiments.

The above description of the embodiments of the image processing apparatus, computer device and storage medium is similar to the description of the aforementioned method embodiments, and these embodiments have similar technical description and beneficial effects as the corresponding method embodiments, which will not be repeated herein due to space limitations, and may be referred to the description of the aforementioned method embodiments. For technical details that are not disclosed in the embodiments of the image processing apparatus, computer device and storage medium of the disclosure, please refer to the description of the method embodiments of the disclosure for understanding. It is to be understood that the expression “one embodiment” or “an embodiment” throughout the specification mean that particular features, structures, or characteristics related to the embodiment are included in at least one embodiment of the disclosure. Therefore, the expression “in one embodiment” or “in an embodiment” appearing at various places throughout the specification may not necessarily refer to the same embodiment. Furthermore, these particular features, structures, or characteristics may be combined in one or more embodiments in any suitable manner. It is to be understood that in various embodiments of the disclosure, the serial numbers of the aforementioned processes do not imply the order of execution. The order of execution of the processes should be determined by their functions and internal logic, and should not constitute any limitation on the implementation processes of the embodiments of the disclosure. The aforementioned serial numbers of the embodiments of the disclosure are only for the purpose of description and do not represent advantages or disadvantages of the embodiments.

It is to be noted that the terms herein, such as “include”, “contain”, or any other variations thereof, are intended to cover non-exclusive inclusion, such that a process, method, object, or apparatus including a series of elements includes not only those elements, but also other elements that are not expressly listed or that are inherent to such process, method, object or apparatus. Without further limitation, an element limited by the expression “including a . . . ” does not preclude the existence of other identical elements in the process, method, object, or apparatus that includes the element.

In some embodiments provided by the disclosure, it is to be understood that the disclosed devices and methods may be implemented in other manners. The device embodiments described above are only schematic. For example, division of the units is only a kind of logic function division, and other division manners may be adopted during a practical implementation. For example, multiple units or components may be combined or integrated into another system, or some features may be neglected or not executed. In addition, coupling or direct coupling or communication connection between various displayed or discussed components may be indirect coupling or communication connection through some interfaces, devices or units, and may be electrical, mechanical, or in other forms.

Units described above as separate components may or may not be physically separated, and components displayed as units may or may not be physical units, which may be located in the same place, or may also be distributed to multiple network units. Part or all of the units may be selected according to actual requirements to implement the purpose of the solution of the embodiments. In addition, various functional units in various embodiments of the disclosure may be integrated into a processing unit, or each unit may be taken as a separate unit, or two or more than two units may be integrated into a unit. The above integrated unit may be implemented in the form of hardware, or in the form of hardware and software functional units. Those of ordinary skill in the art may understand that all or part of the operations for implementing the aforementioned method embodiments may be completed by hardware related to program instructions. The aforementioned program may be stored in a computer-readable storage medium, and the program, when executed, performs operations including the aforementioned method embodiments. The aforementioned storage medium includes various media capable of storing program codes, such as a removable storage device, a ROM, a magnetic disk, an optical disk, or the like.

Alternatively, when the aforementioned integrated unit of the disclosure is implemented in the form of a software functional module and sold or used as an independent product, it may also be stored in a computer-readable storage medium. Based on such understanding, the technical solutions of the embodiments of the disclosure substantially or parts making contributions to the related art may be embodied in the form of a software product. The computer software product is stored in a storage medium, including several instructions for enabling a computer device (which may be a personal computer, a server, a network device, or the like) to perform all or part of the methods described in various embodiments of the disclosure. The aforementioned storage medium includes various media capable of storing program codes, such as a removable storage device, a ROM, a magnetic disk, an optical disk, or the like. The above are only specific implementations of the disclosure, but the scope of protection of the disclosure is not limited thereto. Any variations or replacements apparent to those skilled in the art within the technical scope disclosed by the disclosure shall fall within the scope of protection of the disclosure. Therefore, the scope of protection of the disclosure shall be subject to the scope of protection of the claims.

### INDUSTRIAL APPLICABILITY

An image processing method and apparatus, and a storage medium are provided. A road image collected by an image collection apparatus installed on a vehicle is acquired. Multiple road boundaries in the road image are detected based on the road image. A target road boundary dangerous to the vehicle is determined from the multiple road boundaries.

1. An image processing method, performed by an electronic device, comprising:
acquiring a road image collected by an image collection apparatus installed on a vehicle;
detecting, based on the road image, a plurality of road boundaries in the road image; and
determining a target road boundary, which is dangerous to the vehicle, from the plurality of road boundaries.

2. The method of claim 1, wherein detecting, based on the road image, the plurality of road boundaries in the road image comprises:
detecting the road image to determine a plurality of road boundaries associated with the vehicle.

3. The method of claim 1, wherein detecting, based on the road image, the plurality of road boundaries in the road image comprises:
detecting the road image to obtain a plurality of lanes in the road image; and
connecting respective ends of the plurality of lanes to obtain the plurality of road boundaries.

4. The method of claim 1, wherein detecting, based on the road image, the plurality of road boundaries in the road image comprises:
performing semantic segmentation on the road image to obtain a freespace in the road image; and
determining the plurality of road boundaries based on a contour line of the freespace.

5. The method of claim 1 wherein determining the target road boundary, which is dangerous to the vehicle, from the plurality of road boundaries comprises at least one of:
determining from the plurality of road boundaries, a road boundary adjacent to a lane where the vehicle is located, as the target road boundary;
determining from the plurality of road boundaries, a road boundary having a distance less than a first preset distance from the vehicle, as the target road boundary;
determining from the plurality of road boundaries, a road boundary having a road space less than a preset space from the vehicle, as the target road boundary; or
determining from the plurality of road boundaries, the target road boundary dangerous to the vehicle, based on road information determined by the road image, wherein the road information comprises at least one of a road surface signal, a lane line, a stop line region, a turning sign, or obstacle information in the road image.

6. The method of claim 5, wherein determining from the plurality of road boundaries, the target road boundary dangerous to the vehicle, based on the road information determined by the road image comprises:
determining, based on the road information, a real road region and an unknown region which is unidentifiable by the vehicle;
determining, based on the real road region and the unknown region, a road boundary invisible to the vehicle; and
determining the road boundary invisible to the vehicle as the target road boundary.

7. The method of claim 6, wherein determining, based on the real road region and the unknown region, the road boundary invisible to the vehicle comprises:
converting a collection viewpoint of the real road region and a collection viewpoint of the unknown region into a bird's eye view, to obtain a converted real road region and a converted unknown region;
determining an overlapping region of the converted real road region and the converted unknown region; and
determining a road boundary in the overlapping region as the road boundary invisible to the vehicle.

8. The method of claim 7, wherein determining the overlapping region between the converted real road region and the converted unknown region comprises:
fitting a lane line, a stop line region and a turning sign in the converted real road region to obtain first fitting information;
fitting a lane line, a stop line region and a turning sign in the converted unknown region to obtain second fitting information; and
determining, based on the first fitting information and the second fitting information, the overlapping region between the converted real road region and the converted unknown region.

9. The method of claim 5, wherein after determining the target road boundary, the method further comprises:
determining a driving path of the vehicle based on at least one of the target road boundary or the road information; and
controlling driving of the vehicle based on the driving path.

10. The method of claim 9, wherein determining the driving path of the vehicle based on the road information comprises:
determining a turning orientation and a turning position of the vehicle based on the road surface signal and the turning sign in the road information; and
determining the driving path of the vehicle based on the turning orientation and the turning position.

11. The method of claim 9, wherein controlling the driving of the vehicle based on the driving path comprises:
updating the driving path based on the obstacle information in the road information, to obtain an updated path; and
controlling the driving of the vehicle based on the updated path.

12. The method of claim 9, wherein determining the driving path of the vehicle based on the target road boundary comprises:
updating map data of a position of the vehicle based on the target road boundary, to obtain an updated map; and
determining the driving path of the vehicle based on the updated map.

13. The method of claim 7, wherein after determining the target road boundary, the method further comprises:
controlling the vehicle based on a relationship between the target road boundary and a driving state of the vehicle.

14. The method of claim 13, wherein the relationship between the target road boundary and the driving state of the vehicle comprises at least one of:
a case where a distance between an overlapping region where the target road boundary is located and a road intersection ahead of the vehicle is less than a second preset distance;
a case where a distance between the overlapping region and a position of the vehicle is less than a third preset distance;
a case where an included angle between a driving direction of the vehicle and the target road boundary is less than a preset angle; or
a case where the target road boundary is connected with a lane where the vehicle is located.

15. The method of claim 13, wherein controlling the vehicle comprises:
controlling the vehicle to enter a brake state from a driving state, or controlling the vehicle to drive away from the target road boundary.

16. The method of claim 1, wherein after determining the target road boundary, the method further comprises at least one of:
setting a region of interest based on the target road boundary, and obtaining an image corresponding to the region of interest based on a first resolution, wherein the road image is obtained according to a second resolution, and the second resolution is less than the first resolution; or
obtaining the image corresponding to the region of interest based on a first frame rate, wherein the road image is obtained based on a second frame rate, and the second frame rate is less than the first frame rate.

17. The method of claim 1, wherein after determining the target road boundary, the method further comprises:
collecting road environment information around the target road boundary;
generating notification information based on the road environment information; and
sending the notification information to a rear vehicle of the vehicle, wherein the rear vehicle and the vehicle are located in a same lane and drive in a same direction.

18. An image processing apparatus, comprising a memory for storing instructions and a processor, wherein the processor is configured to execute the instructions to:
acquire a road image collected by an image collection apparatus installed on a vehicle;
detect, based on the road image, a plurality of road boundaries in the road image; and
determine a target road boundary, which is dangerous to the vehicle, from the plurality of road boundaries.

19. The image processing apparatus of claim 18, wherein when detecting, based on the road image, the plurality of road boundaries in the road image, the processor is further configured to execute the instructions to:
detect the road image to determine a plurality of road boundaries associated with the vehicle.

20. A non-transitory computer storage medium having stored thereon computer-executable instructions that, when executed, are capable of implementing operations of:
acquiring a road image collected by an image collection apparatus installed on a vehicle;
detecting, based on the road image, a plurality of road boundaries in the road image; and
determining a target road boundary, which is dangerous to the vehicle, from the plurality of road boundaries.
